(19) United States
(12) Patent Application Publication
(10) Pub. No.: US 2009/0157409 A1
(43) Pub. Date: Jun. 18, 2009

(54) METHOD AND APPARATUS FOR TRAINING DIFFERENCE PROSODY ADAPTATION MODEL, METHOD AND APPARATUS FOR GENERATING DIFFERENCE PROSODY ADAPTATION MODEL, METHOD AND APPARATUS FOR PROSODY PREDICTION, METHOD AND APPARATUS FOR SPEECH SYNTHESIS

(75) Inventors: Yi Lifu, Beijing (CN); Li Jian, Beijing (CN); Lou Xiaoyan, Beijing (CN); Hao Jie, Beijing (CN)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/328,514

(22) Filed: Dec. 4, 2008

(30) Foreign Application Priority Data
Dec. 4, 2007 (CN) 200710197104.6

(51) Int. Cl. G10L 13/00; G10L 21/00; G10L 13/08

(52) U.S. Cl. 704/260; 704/270; 704/262; 704/E13.001; 704/E21.001; 704/259

(57) ABSTRACT

A method includes, generating, for each parameter of the prosody vector, an initial parameter prediction model with a plurality of attributes related to difference prosody prediction and at least part of attribute combinations of the plurality of attributes, in which each of the plurality of attributes and the attribute combinations is included as an item, calculating importance of each item in the parameter prediction model, deleting the item having the lowest importance calculated, re-generating a parameter prediction model with the remaining items, determining whether the re-generated parameter prediction model is an optimal model, and repeating the step of calculating importance and the steps following the step of calculating importance with the re-generated parameter prediction model, if the re-generated parameter prediction model is determined as not an optimal model, wherein the difference prosody vector and all parameter prediction models of the difference prosody vector constitute the difference prosody adaptation model.

### CROSS-REFERENCE TO RELATED APPLICATIONS

This application is based upon and claims the benefit of priority from prior Chinese Patent Application No. 200710197104.6, filed Dec. 4, 2007, the entire contents of which are incorporated herein by reference.

### BACKGROUND OF THE INVENTION

1. Field of the Invention

The present invention relates to information processing technology, especially to technologies of using computers to train difference prosody adaptation model, generate difference prosody adaptation model and predict prosody, and technology of speech synthesis.

2. Description of the Related Art

Generally, the technology of speech synthesis includes text analysis, prosody prediction and speech generation, wherein the prosody prediction is to use a prosody adaptation model to predict prosody characteristic parameters such as tone, rhythm or duration of the synthesized speech. The prosody adaptation model is to establish a mapping relationship between attributes related to prosody prediction and prosody vector, wherein the attributes related to prosody prediction include attributes of language type, speech type and emotion/expression type, and the prosody vector includes parameters such as duration, F0 and etc.

The existing prosody prediction methods include Classify and Regression Tree (CART), Gaussian Mixture Model (GMM) and rule-based methods.

The GMM has been described in detail, for example, in the article “Prosody Analysis and Modeling For Emotional Speech Synthesis”, Dan-ning Jiang, Wei Zhang, Li-qin Shen and Lian-hong Cai, in ICASSP'05, Vol. I, pp. 281-284, Philadelphia, Pa., USA.

The CART and GMM have been described in detail, for example, in the article “Prosody Conversion From Neutral Speech to Emotional Speech”, Jianhua Tao, Yongguo Kang and Aijun Li, in IEEE TRANSACTIONS ON AUDIO, SPEECH AND LANGUAGE PROCESSING, VOL. 14, No. 4, pp. 1145-1154, JULY 2006.

However these methods have the following disadvantages:

1. Most of the existing methods may not represent prosody vector accurately and stably, so the prosody adaptation model is not adaptive enough.
2. The existing methods are limited by the imbalance between model complexity and training data size. In fact, the training data of the emotion/expression corpus is very limit. The conventional models' coefficients can be calculated by data driven methods, but the attributes and attributes combinations of the models are selected manually. As a result, these “partially” data driven methods depend on subjective empiricism.

### BRIEF SUMMARY OF THE INVENTION

The present invention is directed to above existing technical problems, and provides a method and apparatus for training a difference prosody adaptation model, a method and apparatus for generating a difference prosody adaptation model, a method and apparatus of prosody prediction, and a method and apparatus for speech synthesis.

According to one aspect of the present invention, it is provided with a method for training a difference prosody adaptation model, comprising: representing a difference prosody vector with duration and coefficients of F0 orthogonal polynomial; for each parameter of the prosody vector, generating an initial parameter prediction model with a plurality of attributes related to difference prosody prediction and at least part of attribute combinations of the plurality of attributes, in which each of the plurality of attributes and the attribute combinations is included as an item; calculating importance of each item in the parameter prediction model; deleting the item having the lowest importance calculated; re-generating a parameter prediction model with the remaining items; determining whether the re-generated parameter prediction model is an optimal model; and repeating the step of calculating importance, the step of deleting the item, the step of re-generating a parameter prediction model and the step of determining whether the re-generated parameter prediction model is an optimal model, with the re-generated parameter prediction model, if the re-generated parameter prediction model is determined as not an optimal model, wherein the difference prosody vector and all parameter prediction models of the difference prosody vector constitute the difference prosody adaptation model.

According to another aspect of the present invention, it is provided with a method for generating a difference prosody adaptation model, comprising: forming a training sample set for difference prosody vector; and generating a difference prosody adaptation model by using the method for training a difference prosody adaptation model, based on the training sample set for difference prosody vector.

According to another aspect of the present invention, it is provided with a method for prosody prediction, comprising: obtaining values of a plurality of attributes related to neutral prosody prediction and values of at least a part of a plurality of attributes related to difference prosody prediction according to an input text; calculating neutral prosody vector by using the values of attributes related to neutral prosody prediction, based on a neutral prosody prediction model; calculating difference prosody vector by using the values of at least a part of the attributes related to difference prosody prediction and pre-determined values of at least another part of the attributes related to difference prosody prediction, based on a difference prosody adaptation model; and calculating sum of the neutral prosody vector and the difference prosody vector to obtain corresponding prosody; wherein the difference prosody adaptation model is generated by using the method for generating a difference prosody adaptation model.

According to another aspect of the present invention, it is provided with a method for speech synthesis, comprising: predicting prosody of an input text by using the method for prosody prediction; and performing speech synthesis based on the predicted prosody.

According to another aspect of the present invention, it is provided with an apparatus for training a difference prosody adaptation model, comprising: an initial model generator configured to represent a difference prosody vector with duration and coefficients of F0 orthogonal polynomial, and for each parameter of the prosody vector, generate an initial parameter prediction model with a plurality of attributes related to difference prosody prediction and at least part of attribute combinations of the plurality of attributes, in which each of the plurality of attributes and the attribute combinations is included as an item; an importance calculator configured to calculate importance of each item in the parameter prediction model; an item deleting unit configured to delete the item having the lowest importance calculated; a model re-generator configured to re-generate a parameter prediction model with the remaining items after the deletion of the item deleting unit; and an optimization determining unit configured to determine whether the parameter prediction model re-generated by the model re-generator is an optimal model, wherein the difference prosody vector and all parameter prediction models of the difference prosody vector constitute the difference prosody adaptation model.

According to another aspect of the present invention, it is provided with an apparatus for generating a difference prosody adaptation model, comprising: a training sample set for difference prosody vector; and an apparatus for training a difference prosody adaptation model, which trains a difference prosody adaptation model based on the training sample set for difference prosody vector.

According to another aspect of the present invention, it is provided with an apparatus for prosody prediction, comprising: a neutral prosody prediction model; a difference prosody adaptation model generated by the apparatus for generating a difference prosody adaptation model; an attribute obtaining unit configured to obtain values of a plurality of attributes related to neutral prosody prediction and values of at least a part of the plurality of attributes related to difference prosody prediction; a neutral prosody vector prediction unit configured to calculate a neutral prosody vector by using the values of attributes related to neutral prosody prediction, based on the neutral prosody prediction model; a difference prosody vector prediction unit configured to calculate a difference prosody vector by using the values of at least a part of the attributes related to difference prosody prediction and pre-determined values of at least another part of the attributes related to difference prosody prediction, based on the difference prosody adaptation model; and a prosody prediction unit configured to calculate sum of the neutral prosody vector and the difference prosody vector to obtain corresponding prosody.

According to another aspect of the present invention, it is provided with an apparatus for speech synthesis, comprising: the apparatus for prosody prediction; and the apparatus for speech synthesis is configured to perform speech synthesis based on the predicted prosody.

### BRIEF DESCRIPTION OF THE SEVERAL VIEWS OF THE DRAWING

FIG. 1 is a flowchart of a method for training a difference prosody adaptation model according to one embodiment of the present invention;

FIG. 2 is a flowchart of a method for generating a difference prosody adaptation model according to one embodiment of the present invention;

FIG. 3 is a flowchart of a method for prosody prediction according to one embodiment of the present invention;

FIG. 4 is a flowchart of a method for speech synthesis according to one embodiment of the present invention;

FIG. 5 is a schematic block diagram of an apparatus for training a difference prosody adaptation model according to one embodiment of the present invention;

FIG. 6 is a schematic block diagram of an apparatus for generating a difference prosody adaptation model according to one embodiment of the present invention;

FIG. 7 is a schematic block diagram of an apparatus for prosody prediction according to one embodiment of the present invention; and

FIG. 8 is a schematic block diagram of an apparatus for speech synthesis according to one embodiment of the present invention.

### DETAILED DESCRIPTION OF THE INVENTION

It is believed that the above and other objectives, characteristics and advantages of the present invention will be more apparent with the following detailed description of the specific embodiments for carrying out the present invention taken in conjunction with the drawings.

In order to facilitate the understanding of the following embodiments, firstly Generalized Linear Model (GLM) and Bayes Information Criterion (BIC) are introduced.

The GLM model is a generalization of multivariate regression model. The GLM parameter prediction model predicts parameter \hat{d} from attribute A of speech unit s by:

$${d}_{i} = {\hat{d}}_{i} + {e}_{i} = {h}^{- 1} ( {β}_{0} + {\sum }_{j = 1}^{p} {β}_{j} {f}_{j} ( A ) ) + {e}_{i} \qquad ( 1 )$$

where h is a link function. Usually, it is assumed that the distribution of d is of exponential family. Using different link functions, different exponential distributions of d can be obtained. The GLM can be used in either linear modeling or non-linear modeling.

A criterion is need for comparing the performance of different models. The simpler a model is, the more reliable predict results for outlier data is, while the more complex a model is, the more accurate prediction for training data is. The BIC criterion is a widely used evaluation criterion, which gives a measurement integrating both the precision and the reliability and is defined by:

BIC=N log(SSE/N)+p log N (2)

where SSE is sum square of prediction errors e. The first part of right side of equation (2) indicates the precision of the model and the second part indicates the penalty for the model complexity. When the number of training samples N is fixed, the more complex the model is, the larger the dimension p is, the more precise the model can predict for the training data, and the smaller the SSE is. So the first part will be smaller while the second part will be larger, and vice versa. The decrease of one part will lead to the increase of the other part. When the summation of the two parts is the minimum, the model is optimal. The BIC can reach a good balance between the model complexity and database size, this helps to overcome the data sparsity and attributes interaction problem.

Next, the preferable embodiments of the present invention will be described in detail in conjunction with the drawings.

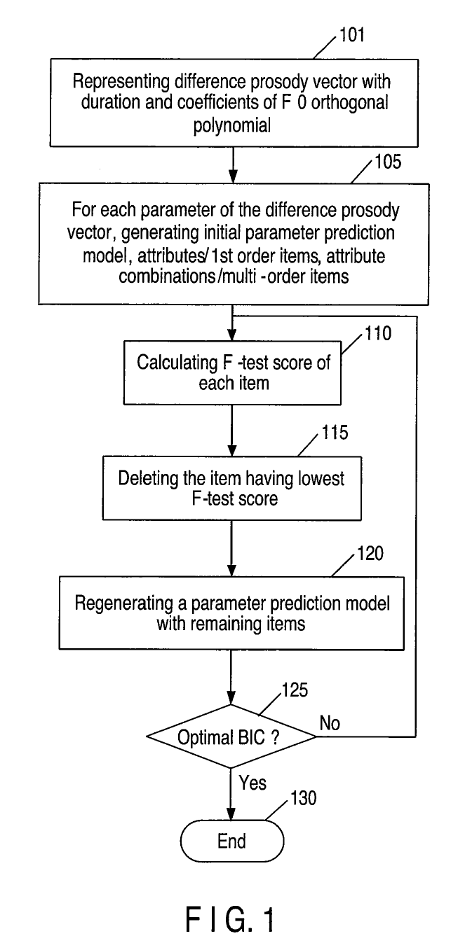

FIG. 1 is a flowchart of a method for training a difference prosody adaptation model according to one embodiment of the present invention. This embodiment will be described in conjunction with the figure.

As shown in FIG. 1, firstly at Step 101, a difference prosody vector is represented with duration and coefficients of F0 orthogonal polynomial. In the embodiment, the difference prosody vector is used to represent the differences between the emotion/expression prosody data and the neutral data. Specifically, in this embodiment, a second-order (or high-order) Legendre orthogonal polynomial is chosen for the F0 representation in the difference prosody vector. The polynomial also can be considered as approximations of Taylor's expansion of a high-order polynomial, which is described in the article “F0 generation for speech synthesis using a multi-tier approach”, Sun X., in Proc. ICSLP'02, pp. 2077-2080. Moreover, orthogonal polynomials have very useful properties in the solution of mathematical and physical problems. There are two main differences between F0 representation proposed inhere and the representation proposed in the above-mentioned article. The first one is that an orthogonal quadratic approximation is used to replace the exponential approximation. The second one is that the segmental duration is normalized within a range of [−1, 1]. These changes will help improving the goodness of fit in the parameterization.

Legendre polynomials are described as following. Classes of these polynomials are defined over a range t□[−1, 1] that obey an orthogonality relation in equation 3.

$$\begin{matrix}{\int }_{- 1}^{1} {P}_{m} ( t ) {P}_{n} ( t ) d t = {δ}_{mn} {c}_{n} & ( 3 ) \\ {δ}_{mn} = \{ \begin{matrix}1 , & when & m = n \\ 0 , & when & m \neq n\end{matrix} & ( 4 )\end{matrix}$$

Where δₘₙ is the Kronecker delta and cₙ=2/(2n+1). The first three Legendre polynomials are shown in Eq. (5)-(7).

$$\begin{matrix}{p}_{0} ( t ) = 1 & ( 5 ) \\ {p}_{1} ( t ) = t & ( 6 ) \\ {p}_{2} ( t ) = \frac{1}{2} ( 3 {t}^{2} - 1 ) & ( 7 )\end{matrix}$$

Next, for every syllable we define:

T(t)=a₀p₀(t)+a₁p₁(t) (8)

F(t)=a₀aₚ(t)+a₁p₁(t)+a₂p₂(t) (9)

Where T(t) represents the underlying F0 target, F(t) represents the surface F0 contour. Coefficient a₀, a₁ and a₂ are Legendre coefficients. a₀ and a₁ represent the intercept and the slope of the underlying F0 target and a₂ is the coefficient of the quadratic approximation part.

Next, at Step 105, an initial parameter prediction model is generated for each of the parameters in the difference prosody vector, i.e. duration t, the coefficient of the F0 orthogonal polynomial a₀, a₁ and a₂. In this embodiment, each of the initial parameter prediction models is represented by using GLM. The GLM model corresponding to the parameter t, a₀, a₁ and a₂ is respectively:

$$\begin{matrix}{t}_{i} = {\hat{t}}_{i} + {e}_{i} = {h}^{- 1} ( {β}_{0} + {\sum }_{j = 1}^{p} {β}_{j} {f}_{j} ( A ) ) + {e}_{i} & ( 10 ) \\ {a}_{{0}_{i}} = {{\hat{a}}_{0}}_{i} + {e}_{i} = {h}^{- 1} ( {β}_{0} + {\sum }_{j = 1}^{p} {β}_{j} {f}_{j} ( A ) ) + {e}_{i} & ( 11 ) \\ {a}_{{1}_{i}} = {{\hat{a}}_{1}}_{i} + {e}_{i} = {h}^{- 1} ( {β}_{0} + {\sum }_{j = 1}^{p} {β}_{j} {f}_{j} ( A ) ) + {e}_{i} & ( 12 ) \\ {a}_{{2}_{i}} = {{\hat{a}}_{2}}_{i} + {e}_{i} = {h}^{- 1} ( {β}_{0} + {\sum }_{j = 1}^{p} {β}_{j} {f}_{j} ( A ) ) + {e}_{i} & ( 13 )\end{matrix}$$

Here, the GLM model (10) for the parameter t will be described firstly.

Specifically, the initial Difference prosody adaptation model of the parameter t is generated with a plurality of attributes related to difference prosody prediction and the attribute combinations of these attributes. As described above, the attributes related to difference prosody prediction can be roughly divided into attributes of language type, speech type and emotion/expression type, for example, including emotion/expression status such as happy, sad, angry, etc., position of a Chinese character in a sentence such as beginning or end of the sentence, tone and sentence type such as exclamatory sentence, imperative sentence, interrogatory sentence, etc.

In this embodiment, GLM model is used to represent these attributes and attribute combinations. To facilitate explanation, it is assumed that only emotion/expression status and tone are the attributes related to difference prosody prediction. The form of the initial parameter prediction model is as follows: parameter˜emotion/expression status+tone+emotion status*tone, wherein emotion/expression status*tone means the combination of emotion/expression status and tone, which is a 2nd order item.

It can be understood that when the number of the attributes increases, there may appear a plurality of 2nd order items, 3rd order items and so on as a result of attribute combination.

In addition, in this embodiment, when the initial parameter model is generated, only a part of attribute combinations can be selected, for example, only those attribute combinations of up to 2nd order are selected. Of course, it is possible to select the attribute combinations of up to 3rd order or to add all attribute combinations into the initial parameter prediction model.

In a word, the initial parameter prediction model includes all individual attributes (1st order items) and at least part of the attribute combinations (2nd order items or multi-order items), wherein each of the above attributes or attribute combinations is regard as one item. In this way, the initial parameter prediction model can be automatically generated by using simply rules instead of being set manually based on empiricism as prior art does.

Next, at Step 110, importance (score) of each item is calculated with F-test. As a well known standard statistical method, F-test has been described in detail in “Probability and Statistics” written by Sheng Zhou, Xie Shiqian and Pan Chengyi, 2002, Second Edition, Higher Education Press, it will not be repeated here.

It should be noted that although F-test is used in this embodiment, other statistical methods can also be used, for example Chisq-test, etc.

Next, at Step 115, an item having the lowest score of F-test is deleted from the initial parameter prediction model. Then, at Step 120, a parameter prediction model is re-generated with the remaining items.

Next, at Step 125, BIC value of the re-generated parameter prediction model is calculated, and then the above-mentioned method is used to determine whether the model is optimal. If the determination result is “Yes,” the re-generated parameter prediction model is regarded as an optimal model and the process ends at Step 130. If the determination result is “No,” the process returns to Step 110, the importance (score) of each item of the re-generated parameter prediction model is re-calculated, the item having the lowest importance is deleted (Step 115) and the parameter prediction model is re-generated with the remaining items (Step 120) until an optimal parameter prediction model is obtained.

The parameter prediction models for the parameter a₀, a₁ and a₂ are trained according to the same steps as the steps used for the parameter t.

Finally, four parameter prediction models for the parameter t, a₀, a₁ and a₂ are obtained and used with the difference prosody vector to form the difference prosody adaptation model.

It can be seen from above description that this embodiment constructs a reliable and precise GLM-based difference prosody adaptation model based on small corpus and uses the duration and the coefficients of F0 orthogonal polynomial. This embodiment constructs and trains a difference prosody adaptation model by using a Generalized Linear Model (GLM) based modeling method and an attribute selection method of stepwise regression based on F-test and Bayes Information Criterion (BIC). Since the model structure of GLM of this embodiment is flexible in structure and adapts to the training data easily, so that the problem of data sparsity can be overcome. Further, the important attribute interactions can be selected automatically by the method of stepwise regression.

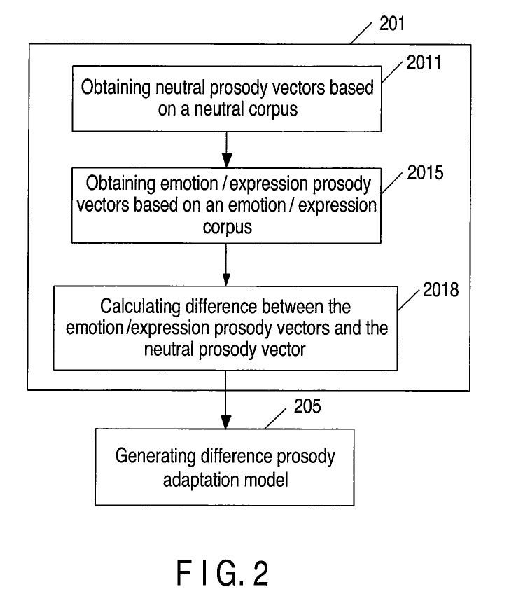

Under the same inventive concept, FIG. 2 is a flowchart of a method for generating a difference prosody adaptation model according to one embodiment of the present invention. This embodiment will be described in conjunction with the figure. For the same portions as those of the above embodiments, the description of which will be omitted properly. The difference prosody adaptation model which is generated by using the method of this embodiment will be used in a method or apparatus for prosody prediction and a method or apparatus for speech synthesis which will be described later in other embodiments.

As shown in FIG. 2, firstly at Step 201, a training sample set for difference prosody vector is formed. The training sample set for the difference prosody vector is the training data used to train the difference prosody adaptation model. As described above, the difference prosody vector is the difference between emotional/expressive data in an emotion/expression corpus and neutral prosody data. Therefore, the training sample set for difference prosody vector is based on an emotion/expression corpus and a neutral corpus.

Specifically, at Step 2011, neutral prosody vectors represented with duration and coefficients of F0 orthogonal polynomial are obtained based on a neutral corpus. Then at Step 2015, emotion/expression prosody vectors represented with duration and coefficients of F0 orthogonal polynomial are obtained based on the emotion/expression corpus. At Step 2018, differences between the emotion/expression prosody vectors and the neutral prosody vectors obtained in Step 2011 are calculated to form the training sample set for difference prosody vectors.

Then at Step 205, based on the formed training sample set for difference prosody vector, the difference prosody adaptation model is generated by using the method for training a difference prosody adaptation model as described in the above embodiments. Specifically, the training samples of each parameter is derived from the training sample set for difference prosody vector and used to train the parameter prediction model of each parameter to obtain the optimal parameter prediction model of each parameter. Thus the optimal parameter prediction model of each parameter and the difference prosody vector constitute the difference prosody adaptation model.

It can be seen from above description that the method for generating a difference prosody adaptation model of this embodiment can generate the difference prosody adaptation model by using the method for training a difference prosody adaptation model according to the training sample set which is obtained based on the emotion/expression corpus and the neutral corpus. The generated difference prosody adaptation model can easily adapt to the training data, so that the problem of data sparsity can be overcome, and the important attributes interactions can be selected automatically.

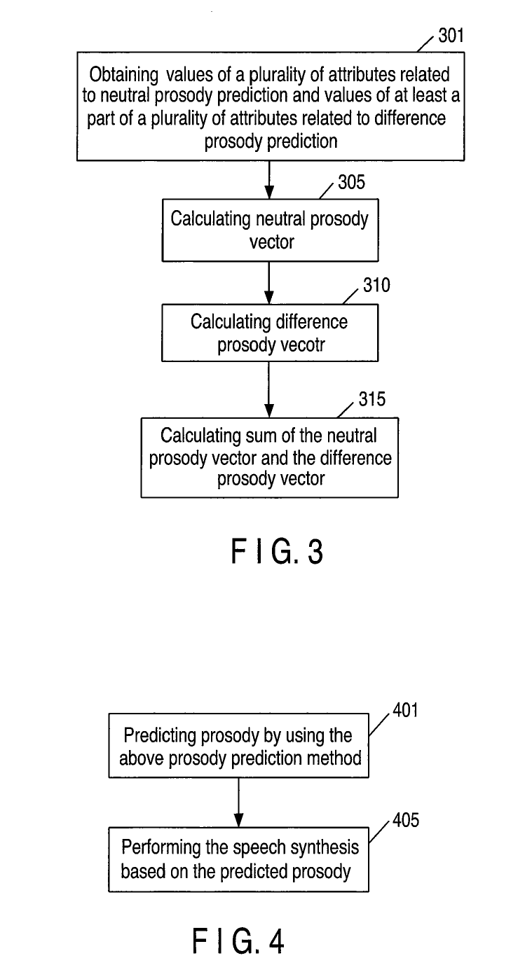

Under the same inventive concept, FIG. 3 is a flowchart of a method for prosody prediction according to one embodiment of the present invention. This embodiment will be described in conjunction with the figure. For the same portions as those of the above embodiments, their descriptions will be omitted properly.

As shown in FIG. 3, at Step 301, values of a plurality of attributes related to neutral prosody prediction and values of at least a part of a plurality of attributes related to difference prosody prediction are obtained according to an input text. Specifically, for example, they can be obtained directly from the input text, or obtained via grammatical and syntactic analysis. It should be noted that the present embodiment can employ any known or future method to obtain these corresponding attributes and is not limited to a particular manner, and the obtaining manner also corresponds to the selection of the attributes.

In the present embodiment, a plurality of attributes related to neutral prosody prediction includes attributes of language type and attributes of speech type. Table 1 exemplarily lists some attributes that may be used as attributes related to neutral prosody prediction.

TABLE 1
attributes related to neutral prosody prediction

| Attribute | Description |
|---|---|
| Pho | current phoneme |
| ClosePho | another phoneme in the same syllable |
| PrePho | the neighboring phoneme in the previous syllable |
| NextPho | the neighboring phoneme in the next syllable |
| Tone | Tone of the current syllable |
| PreTone | Tone of the previous syllable |
| NextTone | Tone of the next syllable |
| POS | Part of speech |
| DisNP | Distance to the next pause |
| DisPP | Distance to the previous pause |
| PosWord | Phoneme position in the lexical word |
| ConWordL | Length of the current, previous and next lexical word |
| SNumW | Number of syllables in the lexical word |
| SPosSen | Syllable position in the sentence |
| WNumSen | Number of lexical words in the sentence |
| SpRate | Speaking rate |

As described above, the attributes related to difference prosody prediction can include emotion/expression status, position of a Chinese character in a sentence, tone and sentence type. However, the value of the attribute “emotion/expression status” cannot be obtained from the input text, and is pre-determined by a user as required. That is, the values of three attributes “position of a Chinese character in a sentence”, “tone” and “sentence type” can be obtained from the input text.

Then, at Step 305, the neutral prosody vector is calculated by using the values of the plurality of attributes related to neutral prosody prediction obtained in Step 301 based on the neutral prosody prediction model. In this embodiment, the neutral prosody prediction model is pre-trained based on the neutral corpus.

Then at Step 310, based on the difference prosody adaptation model, the difference prosody vector is calculated by using the values of at least a part of the plurality of attributes related to difference prosody prediction obtained in Step 301 and pre-determined values of at least another part of the plurality of attributes related to difference prosody prediction. The difference prosody adaptation model is generated by using the method for generating a difference prosody adaptation model of the embodiment shown in FIG. 2.

Finally, at Step 315, the sum of the neutral prosody vector obtained in Step 305 and the difference prosody vector obtained in Step 310 is calculated to obtain the corresponding prosody.

It can be seen from above description that the method for prosody prediction of this embodiment can predict the prosody by compensating the neutral prosody with the difference prosody based on the neutral prosody prediction model and the difference prosody adaptation model, and the prosody prediction is flexible and accurate.

Under the same inventive concept, FIG. 4 is a flowchart of a method for speech synthesis according to one embodiment of the present invention. This embodiment will be described in conjunction with the figure. For the same portions as those of the above embodiments, the description of which will be omitted properly.

As shown in FIG. 4, firstly at Step 401, the prosody of the input text is predicted by using the method for prosody prediction described in the above embodiment. Then, at Step 405, speech synthesis is performed according to the predicted prosody.

It can be seen from above description that the method for speech synthesis of this embodiment predicts the prosody of the input text by using the method for prosody prediction described in the above embodiments and further performs speech synthesis according to the predicted prosody. It can easily adapt to the training data and overcome the problem of data sparsity. As a result, the method for speech synthesis of this embodiment can perform speech synthesis automatically and more precisely. The synthesized speech is more logical and understandable.

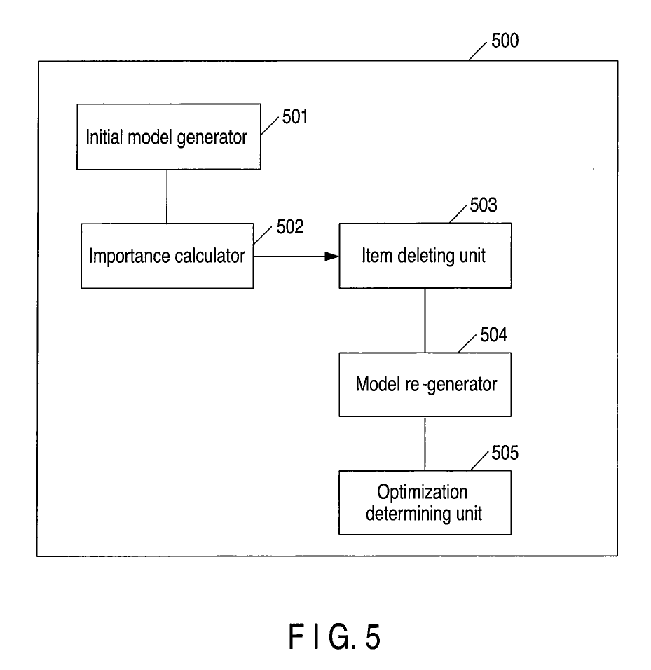

Under the same inventive concept, FIG. 5 is a schematic block diagram of an apparatus for training a difference prosody adaptation model according to one embodiment of the present invention. This embodiment will be described in conjunction with the figure. For the same portions as those of the above embodiments, the description of which will be omitted properly.

As shown in FIG. 5, the apparatus 500 for training a difference prosody adaptation model of this embodiment comprises: an initial model generator 501 configured to represent a difference prosody vector with duration and coefficients of F0 orthogonal polynomial, and for each parameter of the difference prosody vector, generate an initial parameter prediction model with a plurality of attributes related to difference prosody prediction and at least part of attribute combinations of the plurality of the attributes, in which each of the plurality of attributes and the attribute combinations is included as an item; an importance calculator 502 configured to calculate importance of each item in the parameter prediction model; an item deleting unit 503 configured to delete the item having the lowest importance calculated; a model re-generator 504 configured to re-generate a parameter prediction model with the remaining items after the deletion of the item deleting unit; and an optimization determining unit 505 configured to determine whether the parameter prediction model re-generated by the model re-generator is an optimal model; wherein the difference prosody vector and all parameter prediction models of the difference prosody vector constitute the difference prosody adaptation model.

Similarly to the above embodiments, in this embodiment, the difference prosody vector is represented with the duration and the coefficients of the F0 orthogonal polynomial, and a GLM parameter prediction model is built for each parameter of the difference prosody vector t, a₀, a₁ and a₂. Each parameter prediction model is trained to obtain the optimal parameter prediction model for each parameter. The difference prosody adaptation model is constituted with all parameter prediction models and the difference prosody vector together.

As described above, the attributes related to difference prosody prediction can include the attributes of language type, speech type and emotion/expression type, for example, any attributes selected from emotion/expression status, position of a Chinese character in the sentence, tone and sentence type.

As described above, the attributes related to difference prosody prediction can include emotion/expression status, position of a Chinese character in a sentence, tone and sentence type. However, the value of the attribute “emotion/expression status” cannot be obtained from the input text, and is pre-determined by a user as required. That is, the attribute obtaining unit 703 can obtain the values of three attributes “position of a Chinese character in a sentence”, “tone” and “sentence type” from the input text.

Further, the importance calculator 502 calculates the importance of each item with F-test.

Further, the optimization determining unit 505 determines whether the re-generated parameter prediction model is an optimal model based on Bayes Information Criterion (BIC).

In addition, according to a preferable embodiment of the present invention, the at least part of the attribute combinations include all 2nd order attribute combinations of the attributes related to difference prosody prediction.

It should be noted that the apparatus 500 for training a difference prosody adaptation model of this embodiment and its components can be implemented with specifically designed circuits or chips, and also can be implemented by executing corresponding programs on a general computer (processor). Also, the apparatus 500 for training a difference prosody adaptation model in the present embodiment may operationally perform the method for training a difference prosody adaptation model of the embodiment shown in FIG. 1.

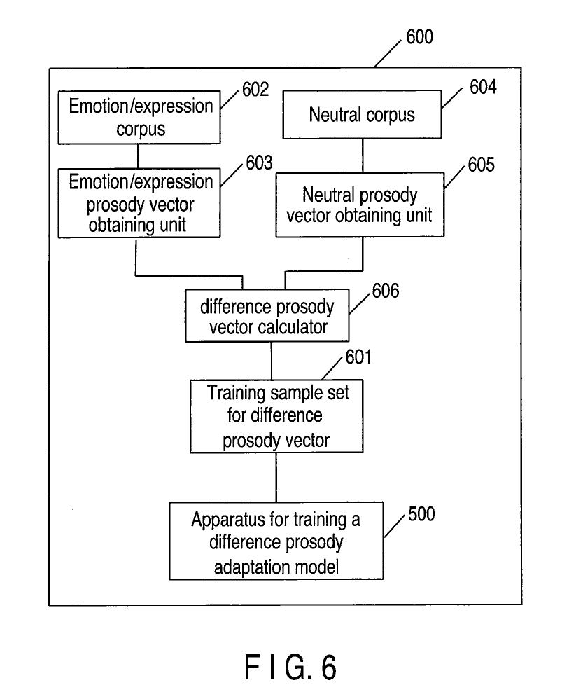

Under the same inventive concept, FIG. 6 is a schematic block diagram of an apparatus for generating a difference prosody adaptation model according to one embodiment of the present invention. This embodiment will be described in conjunction with the figure. For the same portions as those of the above embodiments, the description of which will be omitted properly.

As shown in FIG. 6, the apparatus 600 for generating a difference prosody adaptation model of this embodiment comprises: a training sample set 601 for difference prosody vector; and an apparatus for training a difference prosody adaptation model which can be the apparatus 500 for training a difference prosody adaptation model. The apparatus 500 trains the difference prosody adaptation model based on the training sample set 601 for difference prosody vector.

Further, the apparatus 600 for generating a difference prosody adaptation model of this embodiment comprises: a neutral corpus 602 which contains neutral language materials; a neutral prosody vector obtaining unit 603 configured to obtain the neutral prosody vector represented with the duration and F0 orthogonal polynomial based on the neutral corpus 602; an emotion/expression corpus 604 which contains emotion/expression language materials; an emotion/expression prosody vector obtaining unit 605 configured to obtain the emotion/expression prosody vector represented with the duration and F0 orthogonal polynomial based on the emotion/expression corpus 604; and a difference prosody vector calculator 606 configured to calculate the difference between the emotion/expression prosody vector and the neutral prosody vector and provide to the training sample set 601 for difference prosody vector.

It should be noted that the apparatus 600 for generating a difference prosody adaptation model of this embodiment and its components can be implemented with specifically designed circuits or chips, and also can be implemented by executing corresponding programs on a general computer (processor). Also, the apparatus 600 for generating a difference prosody adaptation model in the present embodiment may operationally perform the method for generating a difference prosody adaptation model of the embodiment shown in FIG. 2.

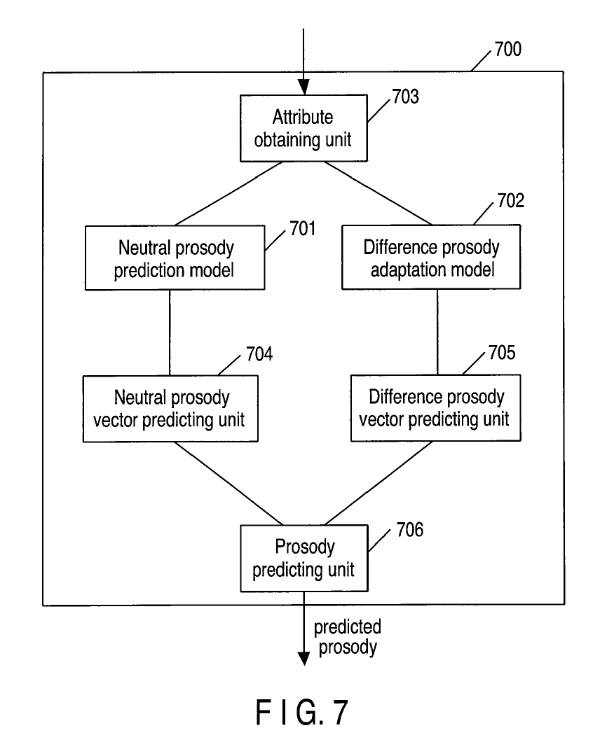

Under the same inventive concept, FIG. 7 is a schematic block diagram of an apparatus 700 for prosody prediction of this embodiment according to one embodiment of the present invention. This embodiment will be described in conjunction with the figure. For the same portions as those of the above embodiments, the description of which will be omitted properly.

As shown in FIG. 7, the apparatus 700 for prosody prediction of this embodiment comprises: a neutral prosody prediction model 701 which is pre-trained based on the neutral language materials; a difference prosody adaptation model 702 which is generated by the apparatus 600 for generating a difference prosody adaptation model described in the above embodiment; an attribute obtaining unit 703 which obtains values of the plurality of attributes related to neutral prosody prediction and values of at least a part of the plurality of attributes related to difference prosody prediction based on an input text; a neutral prosody vector predicting unit 704 which calculates the neutral prosody vector by using the values of the plurality of attributes related to neutral prosody prediction obtained by the attribute obtaining unit 703, based on the neutral prosody prediction model 701; a difference prosody vector predicting unit 705 which calculates the difference prosody vector by using the values of at least a part of the plurality of attributes related to difference prosody prediction obtained by the attribute obtaining unit 703 and pre-determined values of at least another part of the plurality of attributes related to difference prosody prediction, based on the difference prosody adaptation model 702; and a prosody predicting unit 706 which calculates sum of the neutral prosody vector and the difference prosody vector to obtain corresponding prosody.

In the present embodiment, the plurality of attributes related to neutral prosody prediction include the attributes of language type and speech type, for example, include any attributes selected form the above Table 1.

It should be noted that the apparatus 700 for prosody prediction of this embodiment and its components can be implemented with specifically designed circuits or chips, and also can be implemented by executing corresponding programs on a general computer (processor). Also, the apparatus 700 for prosody prediction in the present embodiment may operationally perform the method for prosody prediction of the embodiment shown in FIG. 3.

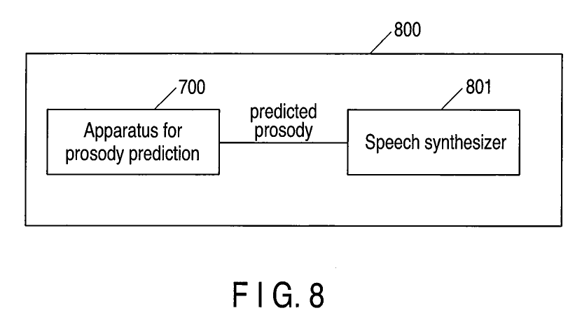

Under the same inventive concept, FIG. 8 is a schematic block diagram of an apparatus for speech synthesis of this embodiment according to one embodiment of the present invention. This embodiment will be described in conjunction with the figure. For the same portions as those of the above embodiments, the description of which will be omitted properly.

As shown in FIG. 8, the apparatus 800 for speech synthesis of this embodiment comprises: an apparatus for prosody prediction which can be the apparatus 700 for prosody prediction described in the above embodiment; and a speech synthesizer 801 which can be the existing speech synthesizer and perform speech synthesis based on the prosody predicted by the apparatus 700 for prosody prediction.

It should be noted that the apparatus 800 for speech synthesis of this embodiment and its components can be implemented with specifically designed circuits or chips, and also can be implemented by executing corresponding programs on a general computer (processor). Also, the apparatus 800 for speech synthesis in the present embodiment may operationally perform the method for speech synthesis of the embodiment shown in FIG. 4.

Although a method and apparatus for training a difference prosody adaptation model, a method and apparatus for generating a difference prosody adaptation model, a method and apparatus for prosody prediction, and a method and apparatus for speech synthesis are described in detail accompanying with the concrete embodiment in the above, the present invention is not limited the above. It should be understood for persons skilled in the art that the above embodiments may be varied, replaced or modified without departing from the spirit and the scope of the present invention.

What is claimed is:

1. A method for training a difference prosody adaptation model, comprising:
representing a difference prosody vector with duration and coefficients of F0 orthogonal polynomial;
for each parameter of the prosody vector,
generating an initial parameter prediction model with a plurality of attributes related to difference prosody prediction and at least part of attribute combinations of the plurality of attributes, in which each of the plurality of attributes and the attribute combinations is included as an item;
calculating importance of each item in the parameter prediction model;
deleting the item having the lowest importance calculated;
re-generating a parameter prediction model with the remaining items;
determining whether the re-generated parameter prediction model is an optimal model; and
repeating the step of calculating importance, the step of deleting the item, the step of re-generating a parameter prediction model and the step of determining whether the re-generated parameter prediction model is an optimal model, with the re-generated parameter prediction model, if the re-generated parameter prediction model is determined as not an optimal model;
wherein the difference prosody vector and all parameter prediction models of the difference prosody vector constitute the difference prosody adaptation model.

2. The method for training a difference prosody adaptation model according to claim 1, wherein said plurality of attributes related to difference prosody prediction includes: attributes of language type, speech type and emotion/expression type.

3. The method for training a difference prosody adaptation model according to claim 1, wherein said plurality of attributes related to difference prosody prediction includes: any attributes selected from emotion/expression status, position of a Chinese character in a sentence, tone and sentence type.

4. The method for training a difference prosody adaptation model according to claim 1, wherein said parameter prediction model is a Generalized Linear Model (GLM).

5. The method for training a difference prosody adaptation model according to claim 1, wherein said at least part of attribute combinations of said plurality of attributes include all 2nd order attribute combinations of said plurality of attributes related to difference prosody prediction.

6. The method for training a difference prosody adaptation model according to claim 1, wherein said step of calculating importance of each said item in said difference prosody adaptation model comprises: calculating the importance of each said item with F-test.

7. The method for training a difference prosody adaptation model according to claim 1, wherein said step of determining whether said re-generated parameter prediction model is an optimal model comprises: determining whether said re-generated parameter prediction model is an optimal model based on Bayes Information Criterion (BIC).

8. The method for training a difference prosody adaptation model according to claim 7, wherein said step of determining whether said re-generated parameter prediction model is an optimal model comprises:
calculating BIC value based on the equation
BIC=N log(SSE/N)+p log N
wherein SSE represents sum square of prediction errors and N represents the number of training sample; and
determining said re-generated parameter prediction model as an optimal model, when the BIC value is the minimum.

9. The method for training a difference prosody adaptation model according to claim 1, wherein said F0 orthogonal polynomial is a second-order or high-order Legendre orthogonal polynomial.

10. The method for training a difference prosody adaptation model according to claim 9, wherein said Legendre orthogonal polynomial is defined by a formula
F(t)=a₀p₀(t)+a₁p₁(t)+a₂p₂(t)
wherein F(t) represents F0 contour, a₀, a₁ and a₂ represent said coefficients, and t belongs to [−1, 1].

11. A method for generating a difference prosody adaptation model, comprising:
forming a training sample set for difference prosody vector; and
generating a difference prosody adaptation model by using the method for training a difference prosody adaptation model according to claim 1, based on the training sample set for difference prosody vector.

12. The method for generating a difference prosody adaptation model according to claim 11, wherein the step of forming a training sample set for difference prosody vector comprises:
obtaining a neutral prosody vector with the duration and coefficients of F0 orthogonal polynomial based on a neutral corpus;
obtaining a emotion/expression prosody vector with the duration and coefficients of F0 orthogonal polynomial based on an emotion/expression corpus; and
calculating difference between the emotion/expression prosody vector and the neutral prosody vector to form the training sample set for difference prosody vector.

13. A method for prosody prediction, comprising:
obtaining values of a plurality of attributes related to neutral prosody prediction and values of at least a part of a plurality of attributes related to difference prosody prediction according to an input text;
calculating a neutral prosody vector by using said values of said plurality of attributes related to neutral prosody prediction, based on a neutral prosody prediction model;
calculating a difference prosody vector by using said values of at least a part of said plurality of attributes related to difference prosody prediction and pre-determined values of at least another part of said plurality of attributes related to difference prosody prediction, based on a difference prosody adaptation model; and
calculating sum of the neutral prosody vector and the difference prosody vector to obtain corresponding prosody;
wherein said difference prosody adaptation model is generated by using the method for generating a difference prosody adaptation model according to claim 11.

14. The method for prosody prediction according to claim 13, wherein said plurality of attributes related to neutral prosody prediction includes: attributes of language type and speech type.

15. The method for prosody prediction according to claim 13, wherein said plurality of attributes related to neutral prosody prediction includes: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

16. The method for prosody prediction according to claim 13, wherein said at least another part of the plurality of attributes related to difference prosody prediction includes the attribute of emotion/expression type.

17. A method for speech synthesis, comprising:
predicting prosody of an input text by using the method for prosody prediction according to claim 13; and
performing speech synthesis based on the predicted prosody.

18. An apparatus for training a difference prosody adaptation model, comprising:
an initial model generator configured to represent a difference prosody vector with duration and coefficients of F0 orthogonal polynomial, and for each parameter of the difference prosody vector, generate an initial parameter prediction model with a plurality of attributes related to difference prosody prediction and at least part of attribute combinations of said plurality of attributes, in which each of said plurality of attributes and said attribute combinations is included as an item;
an importance calculator configured to calculate importance of each said item in said parameter prediction model;
an item deleting unit configured to delete the item having the lowest importance calculated;
a model re-generator configured to re-generate a parameter prediction model with the remaining items after the deletion of said item deleting unit; and
an optimization determining unit configured to determine whether said parameter prediction model re-generated by said model re-generator is an optimal model;
wherein the difference prosody vector and all parameter prediction models of the difference prosody vector form the difference prosody adaptation model

19. The apparatus for training a difference prosody adaptation model according to claim 18, wherein said plurality of attributes related to difference prosody prediction includes: attributes of language type, speech type and emotion/expression type.

20. The apparatus for training a difference prosody adaptation model according to claim 18, wherein said plurality of attributes related to difference prosody prediction includes: any attributes selected from emotion/expression status, position of a Chinese character in a sentence, tone and sentence type.

21. The apparatus for training a difference prosody adaptation model according to claim 18, wherein said parameter prediction model is a Generalized Linear Model (GLM).

22. The apparatus for training a difference prosody adaptation model according to claim 18, wherein said at least part of attribute combinations of said plurality of attributes include all 2nd order attribute combinations of said plurality of attributes related to difference prosody prediction.

23. The apparatus for training a difference prosody adaptation model according to claim 18, wherein said importance calculator is configured to calculate the importance of each said item with F-test.

24. The apparatus for training a difference prosody adaptation model according to claim 18, wherein said optimization determining unit is configured to determine whether said re-generated parameter prediction model is an optimal model based on Bayes Information Criterion (BIC).

25. The apparatus for training a difference prosody adaptation model according to claim 18, wherein said F0 orthogonal polynomial is a second-order or high-order Legendre orthogonal polynomial.

26. The apparatus for training a difference prosody adaptation model according to claim 25, wherein said Legendre orthogonal polynomial is defined by a formula
F(t)=a₀p₀(t)+a₁p₁(t)+a₂p₂(t)
wherein F(t) represents F0 contour, a₀, a₁ and a₂ represent said coefficients, and t belongs to [−1, 1].

27. An apparatus for generating a difference prosody adaptation model, comprising:
a training sample set for difference prosody vector; and
an apparatus for training a difference prosody adaptation model according to claim 18, which trains a difference prosody adaptation model based on the training sample set for difference prosody vector.

28. The apparatus for generating a difference prosody adaptation model according to claim 27, further comprising:
a neutral corpus;
a neutral prosody vector obtaining unit configured to obtain the neutral prosody vector represented with the duration and coefficients of F0 orthogonal polynomial;
an emotion/expression corpus;
an emotion/expression prosody vector obtaining unit configured to obtain the difference prosody vector represented with the duration and coefficients of F0 orthogonal polynomial; and
a difference prosody vector calculator configured to calculate difference between the emotion/expression prosody vector and the neutral prosody vector and provide to said training sample set for difference prosody vector.

29. An apparatus for prosody prediction, comprising:
a neutral prosody prediction model;
a difference prosody adaptation model generated by an apparatus for generating a difference prosody adaptation model according to claim 27;
an attribute obtaining unit configured to obtain values of a plurality of attributes related to neutral prosody prediction and values of at least a part of said plurality of attributes related to difference prosody prediction;
a neutral prosody vector predicting unit configured to calculate the neutral prosody vector by using the values of a plurality of attributes related to neutral prosody prediction, based on said neutral prosody prediction model;
a difference prosody vector predicting unit configured to calculate the difference prosody vector by using the values of at least a part of said plurality of attributes related to difference prosody prediction and pre-determined values of at least another part of said plurality of attributes related to difference prosody prediction, based on said difference prosody adaptation model; and
a prosody predicting unit configured to calculate sum of the neutral prosody vector and the difference prosody vector to obtain corresponding prosody.

30. The apparatus for prosody prediction according to claim 29, wherein said plurality of attributes related to neutral prosody prediction includes: attributes of language type and speech type.

31. The apparatus for prosody prediction according to claim 29, wherein said plurality of attributes related to neutral prosody prediction includes: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

32. The apparatus for prosody prediction according to claim 29, wherein said at least another part of the plurality of attributes related to difference prosody prediction includes the attribute of emotion/expression type.

33. An apparatus for speech synthesis, comprising:
an apparatus for prosody prediction according to claim 29;
wherein said apparatus for speech synthesis is configured to perform speech synthesis based on the predicted prosody.
